(19) United States
(12) Patent Application Publication
(10) Pub. No.: US 2017/0049127 A1
(43) Pub. Date: Feb. 23, 2017

(54) SOFT SERVE DISPENSER

(71) Applicant: Ross Weldy, Bristol, IN (US)

(72) Inventor: Ross Weldy, Bristol, IN (US)

(21) Appl. No.: 14/827,564

(22) Filed: Aug. 17, 2015

(51) Int. Cl. A23G 9/28

(52) U.S. Cl. CPC A23G 9/281

(57) ABSTRACT

A positive displacement chilled food dispenser is provided where liquid enters a portion of a housing where two screws reside. The housing is chilled below the freezing temperature of the liquid. The two screws, when rotating, move the liquid towards a dispensing end. The liquid freezes where it contacts the housing and is scraped by an outside diameter of the two screws. The frozen liquid is then dispensed through a dispensing end. At the dispensing end is an optional valve that selectively shuts the flow of frozen liquid off. Alternatively, a sensor determines how much frozen liquid is dispensed through the dispensing end.

### BACKGROUND OF THE INVENTION

Frozen treats such as ice cream, frozen yogurt, and the like have been a mainstay for people wanting to refresh themselves after a hot day, a meal, or just for a snack. Commonly, soft-serve ice cream or frozen yogurt is dispensed from a machine that both freezes a liquid into a flowable solid then dispenses it. In the current art, the machines use a spiral auger having a single straight blade that scrapes frozen product from the inside diameter of the dispensing cavity. The system has remained largely unchanged for many years and functions, except for the hassle and waste generated by cleaning and the inability to automatically dispense metered amounts. Currently in the art, a large cavity of unused product remains and must be discarded at the end of the day or when a flavor changeover is desired. An improved frozen treat dispenser is needed.

### SUMMARY OF THE INVENTION

The present disclosure describes a device for dispensing a metered amount of frozen product using a positive displacement pump. A set of helical screws reside inside a cavity that is chilled to below the freezing point of the product. One screw has the opposite thread of a second screw. As the helical screws rotate in opposite directions, the outside diameter continuously scrapes frozen product off of an inside wall of the cavity. Because the rotation of the screws positively displace the food product, a metered amount of product can be easily dispensed by controlling the rotation of the screws. Also because the inside available space is mostly consumed by the rotating screws, only a very small amount of product remains inside at any point in time. Another function of the positive displacement pump arrangement is that the system can be easily purged by dispensing any amount leftover. This minimizes the amount of waste when the machine is shut down at the end of use.

### BRIEF DESCRIPTION OF THE DRAWINGS

A preferred embodiment of this invention has been chosen wherein:

FIG. 1 is a side section view of the system;

FIG. 2 is a side section of the housing portion of the system in FIG. 1;

FIG. 3 is an isometric view of the housing portion with the upper and lower screws partially removed;

FIG. 4 is an end view of the upper and lower screw showing the interface portion;

FIG. 5 is a front view of section 5-5 in FIG. 2; and

FIG. 6 is an isometric view of the cover and housing.

### DESCRIPTION OF THE PREFERRED EMBODIMENT

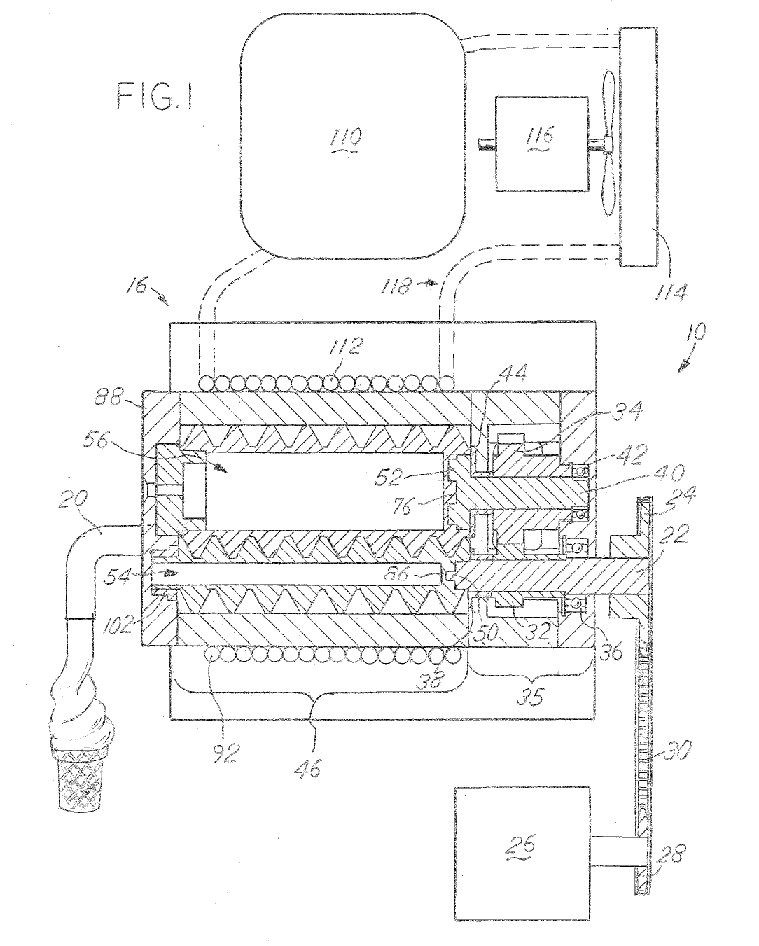

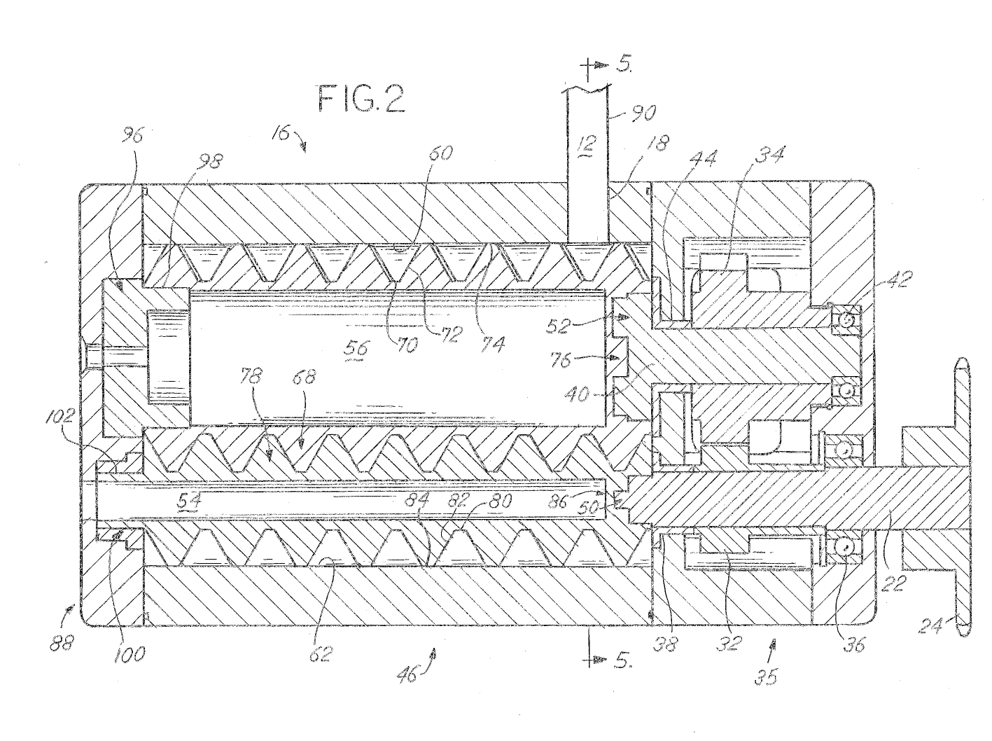

A positive displacement dispensing device 10 is shown in FIG. 1 that cools a liquid 12, FIG. 2 into a frozen product 14, such as ice cream or frozen yogurt. As shown in FIG. 2, the device has a housing 16 with an inlet port 18 and an outlet port 20 FIG. 1.

At the rear of the housing 16 is an input shaft 22 with a driven sprocket 24. A motor 26 with a driving sprocket 28, FIG. 1 as shown in FIG. 1 connected to the driven sprocket 24 by a chain 30 transfers power to the input shaft 22. A keyway and key secures the driven sprocket 24 to the input shaft 22. It is contemplated that the input shaft 22 is driven directly by the motor 26.

Mounted to the input shaft 22 is a driving gear 32, FIG. 2 that meshes with a driven gear 34. The gears 32, 34 are located in the gear portion 35 of the housing 16. Supporting the shaft 22 on the end closest to the driven sprocket 24 is a bearing 36. As shown in FIG. 2, it is a ball bearing, but it could be any other type of device such as a bushing to allow the shaft 22 to rotate. Located past the driving gear 32 is a bushing 38 that supports the shaft 22 at the other end. The driven gear 34 is mounted to a driven shaft 40 which is also supported by a bearing 42 on one end and a bushing 44 on the opposite end. While it is not shown in the FIGS, shaft seals may be implemented on the shafts 22, 40 to prevent any liquid 12 from entering the part of the housing that contains the driving gear 32 and driven gear 34 and also to keep any lubricant from escaping the gearbox. The seal could be integrated into the bushing or other bearing device. It is further contemplated that the gear portion 35 would be capable of carrying a food-grade lubricant. Alternatively, moving parts in the gear portion 35 could have a food-grade coating with lubricating properties.

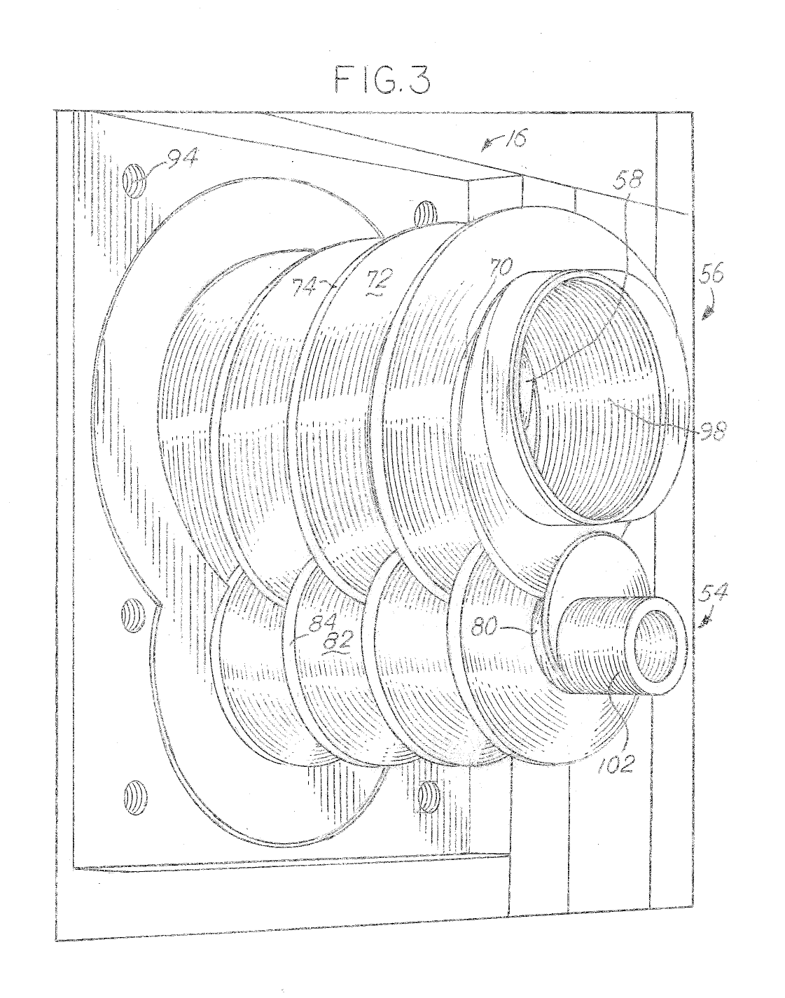

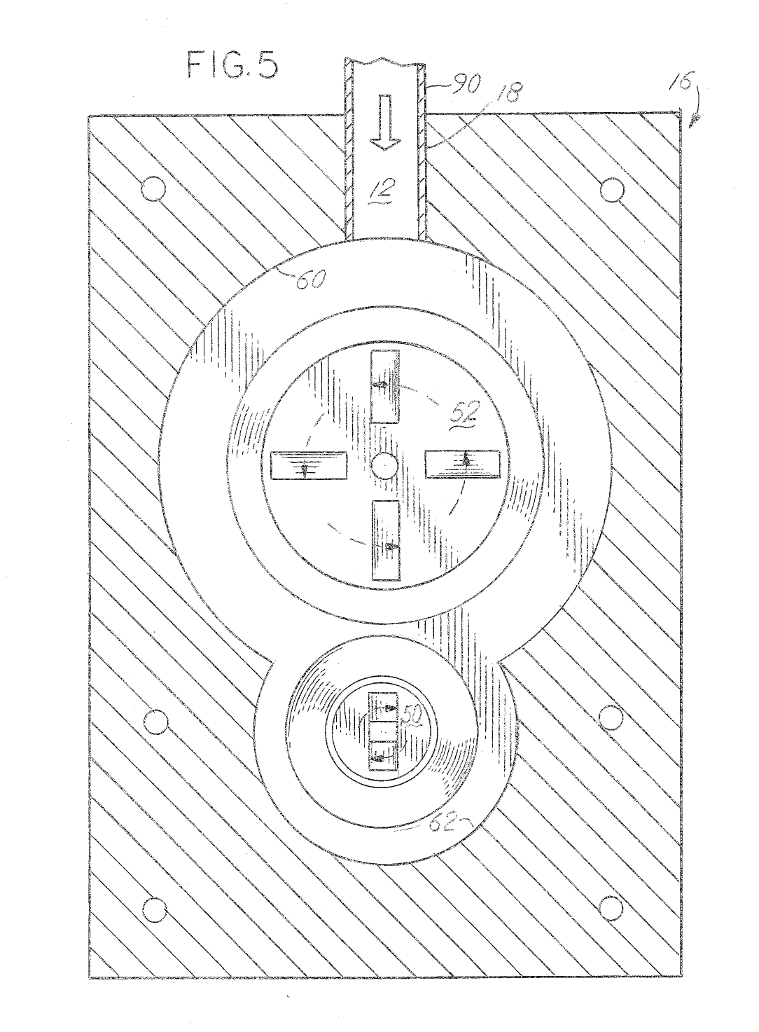

Adjacent to the gear portion 35 of the housing 16 is a cooling portion 46. Ends of the shafts 22, 40 protrude into the cooling portion 46. On the end of the shaft 22 is a coupling portion 50, and similarly, at the end of shaft 40 is another coupling portion 52. Further located in the cooling portion 46 is a removable lower screw 54 and a removable upper screw 56. FIG. 3 shows the upper and lower screws 56, 54 partially removed. As is visible in FIGS. 1 and 2, the housing has an internal cavity. The internal cavity has an upper cylindrical surface 60 and a lower cylindrical surface 62. This is visible in FIGS. 2 and 5. The internal cavity is formed by the two overlapping cylindrical surfaces 60, 62. The internal cavity is sized to receive an upper screw 56 and a lower screw 54. The upper screw 56 as shown is a double lead screw and the lower screw 54 is a single lead screw. Because of this, and in order to have proper meshing of the screws, the diameter of the upper screw 56 is double the lower screw 54. It is contemplated that the upper screw 56 and lower screw 54 could be the same, either both being a single lead or double lead.

The upper screw 56 has a continuous spiral 68 extending from one end to the other. A portion can be seen in FIG. 3. As shown in FIGS. 2 and 3, the upper screw 56 has a left-hand or reverse thread. The spiral 68 has a root 70 and a taper 72 that extends outwardly from the root 70. The taper 72 terminates at a scraping surface 74. The scraping surface 74 has an outer diameter that closely matches the internal surface 60. The closer the scraping surface 74 matches the internal surface 60, the more efficient the overall system. The upper screw 56 has an interface 76 that mates with the coupling portion 52 of the shaft 40. When the upper screw 56 is mated to the shaft 40, rotation of one will cause the other to rotate. The interface 76 and coupling portion 52 allow torque transfer. Because the assembly of the upper screw 56 to the shaft 40 is blind, misalignment could cause assembly difficulties. It is contemplated that the interface 76 and coupling portion 52 contains a ramped surface to allow misalignment as the two are mated but align them and allow single direction torque transfer.

The lower screw 54 has a continuous spiral 78, FIG. 2 extending from one end to the other. As shown, the lower screw 54 has a right-hand thread. It is contemplated that the lower screw 54 is a reverse thread and the upper screw 56 is a right-hand thread. The spiral 78 has a root 80 and a taper 82 that extends outwardly from the root 80, FIG. 3. The taper 82 terminates at a scraping surface 84. The scraping surface 84 has an outer diameter that closely matches the internal surface 62. The closer the scraping surface 84 matches the internal surface 62, the more efficient the overall system. The lower screw 54 has an interface 86 that mates with the coupling portion 50 of the shaft 22. When the lower screw 54 is mated to the shaft 22, rotation of one will cause the other to rotate. The interface 86 and coupling portion 50 allow torque transfer. Because the assembly of the lower screw 54 to the shaft 22 is blind, misalignment could cause assembly difficulties. It is contemplated that the interface 86 and coupling portion 50 contains a ramped surface to allow misalignment as the two are mated but allow single direction torque transfer.

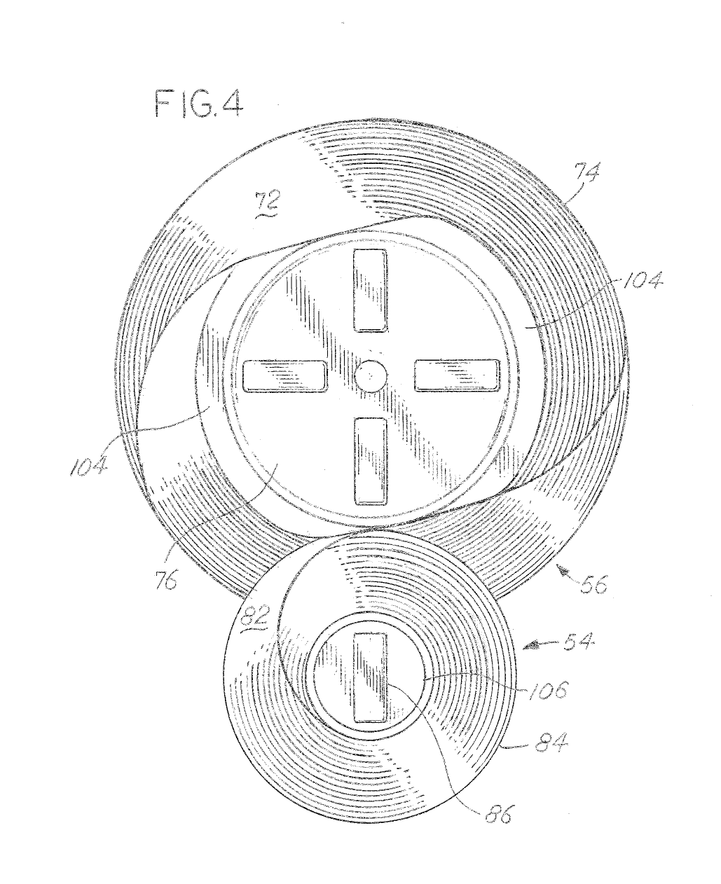

Precise alignment of the upper screw 56 and the lower screw 54 is necessary for proper function and assembly of the device 10. The coupling portion 50, as shown, is a single projection that protrudes into a single receiver on the interface 86 on the lower screw 54. The coupling portion 52 has 4 projections that protrude into corresponding receivers on the interface 76 of the upper screw 56. As shown in FIG. 4, it is possible to assemble the upper screw 56 to the shaft 40 in four different orientations. It is possible to assemble the lower screw 54 to the shaft 22 in two different orientations. Alternate coupling styles are contemplated.

When the lower screw 54 is meshed with the upper screw 56, the root 70 is very close to the scraping surface 84, the taper 72 is close to the taper 82, and the root 80 is close to the scraping surface 74. The close proximity of these surfaces improves the efficiency of the overall system. The combination of the lower screw 54 and the upper screw 56 form a screw-drive positive displacement pump for liquid 12.

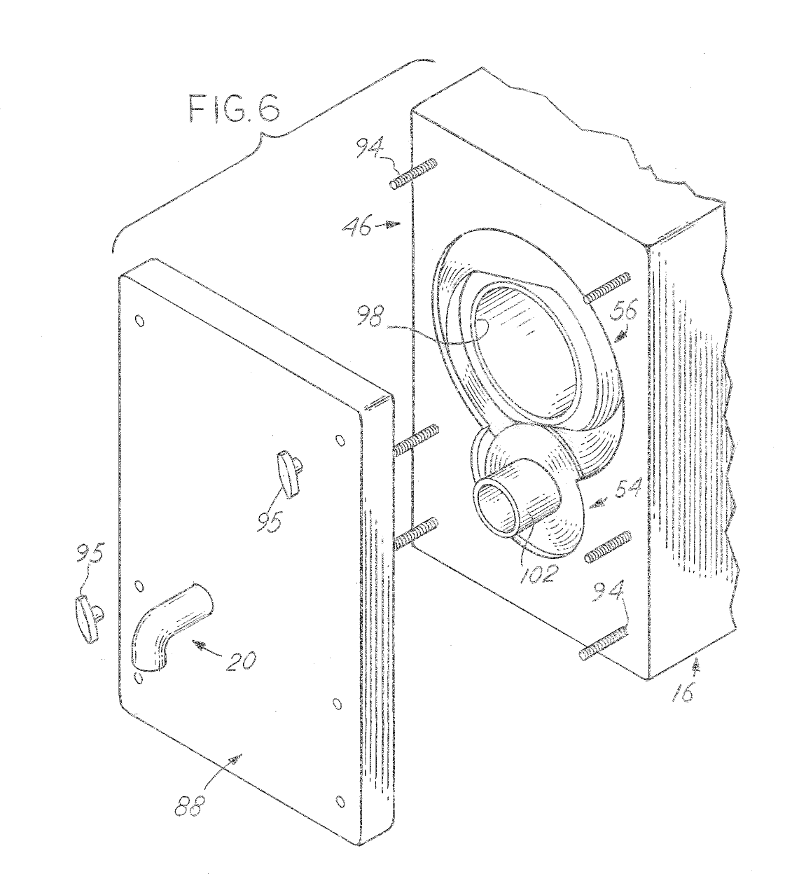

The housing 16 is enclosed by a front removable cover 88, FIGS. 1 and 2 that fits onto pins 94, FIG. 2. The removable cover 88 seals to the cooling portion 46, FIG. 1 and has an upper bushing 96, FIG. 2 that supports one end of the upper screw 56 on a bearing surface 98 and a lower bushing 100 that supports the end of the lower screw 54 on a bearing surface 102. In the embodiment shown in all FIGS, removable cover 88 has captured screws 95, FIG. 6 that serve to both secure the cover 88 to the housing 16 and drive it off of the housing for cleaning. The pins serve to properly align the cover 88 to the housing 16, which then align the upper screw 56 and the lower screw 54 to their respective cylindrical surfaces 60, 62.

The coupling portion 50 engages with the interface 86 and is locked in rotation such that when the driving shaft 22 rotates, the lower screw 54 rotates in concert. Likewise, the coupling portion 52 engages with the interface 76 and is locked in rotation such that when the driven shaft 40 rotates, the upper screw 56 rotates in concert. The coupling portions 50, 52 allow the screws 54, 56 to be removed simply by pulling them out of the housing 16 when the cover 88 has been removed.

On the ends of each screw are thrust surfaces. For example, the upper screw 56 has a thrust surface 104, FIG. 4 that is adjacent to the interface 76. Correspondingly, the lower screw 54 has a thrust surface 106 that is adjacent to the interface 86. It is contemplated that the thrust surfaces 104, 106 are on the interfaces 76, 86. The thrust surfaces 104, 106 carry the axial pressure from the reaction force created when the screws 54, 56 pump the liquid 12 from the inlet 18, FIG. 5 to the outlet 20. The gear portion 35 and bushings 38, 44 mate with the thrust surfaces 104, 106 to provide support. It is further contemplated that the shafts 22, 40 carry the axial load.

The refrigeration system is shown in FIG. 1 with a compressor 110, evaporator coils 112, a condenser 114, and a condenser fan 116. These items are all connected by tubing 118 to allow refrigerant to circulate. Refrigeration of this type is well known in the art. When the compressor 110 is running, the refrigerant is compressed into a liquid in the condenser 114, which is then cooled by the condenser fan 116. The coolant then travels through an orifice, where it expands into the evaporator coils, causing it to lose a significant amount of heat, cooling the cooling portion 46, FIG. 6. Because the cooling portion is made from a heat-conductive material, the evaporator coils heat or cool the cooling portion effectively. A controller can be implemented using temperature sensors to control the compressor's activity, thereby controlling the temperature of the cooling portion 46.

Because the screws and cooling portion form a positive displacement pump, dispensing only occurs when the screws rotate. In order to control the screws, several different methods can be implemented. First, a switch can be connected to the motor 26 such that the motor only turns when the switch is activated. Further, the switch could be attached to a dispensing valve that the user can open or close. When the switch indicates that the valve is open, the motor 26 can be enabled, causing product 14 to be dispensed. When the limit switch indicates the valve is closed, the motor 26 is then turned off to prevent excessive pressure buildup in the housing 16. Alternatively, a pressure sensor (not shown) can be implemented in the housing 16 that can control the motor 26 based on the pressure inside. Another option is to have a sensor or encoder (not shown) located on one of the shafts 22, 40, or the motor 26 such that a controlled amount of product 14 be dispensed, based on the number of revolutions of the screws 54, 56. Because the amount of displacement is known for each revolution, the user could control the amount of product 14 being dispensed using that method. This could eliminate the need for the valve. It is contemplated that the aforementioned controls could be used singularly or in combination with each other to control the dispensing of product 14.

For operation, the user fills a reservoir 90, FIG. 2 with liquid 12, usually some form of frozen dessert, such as ice cream or frozen yogurt. The liquid 12 passes through the inlet port 18 and into the cavity inside the cooling portion 46. The cooling portion 46 is chilled by refrigeration either through an integral or external cooling jacket 92, FIG. 1. As the liquid 12 begins to fill the cavity, it contacts the screws 56, 54. The motor 26 begins to turn, causing the shaft 22 to rotate. The shaft 22, in turn, causes the driving gear 32 and therefore the driven gear 34 to turn. Because these gears directly mesh, the driven gear 34 turns in the opposite direction of the driving gear. As shown, the gear ratio is 2:1 but could be other ratios, depending on the screws 54, 56 they drive.

The cooling portion 46 is cooled sufficiently below the freezing point of the liquid 12, such that the liquid 12 hardens and accumulates on the cylindrical surfaces 60, 62, FIG. 5. The upper screw 56, namely the scraping surface 74 shears off accumulated hardened liquid from the upper cylindrical surface 60 and moves it toward the outlet port 20 as it rotates. Simultaneously, the lower screw 54, namely the scraping surface 84 shears off accumulated hardened liquid from the lower cylindrical surface 62 and moves it toward the outlet port 20 as it rotates.

For cleaning, liquid 12 is removed from the inlet port 18 and the motor 26 is enabled, rotating the screws 54, 56. This drives any remaining liquid 12 from the cooling portion 46 and out of the cooling portion 46. At any point, the refrigeration system is disabled to allow the cooling portion 46 to warm up. Once the cooling portion is devoid of most liquid 12, the cover 88 can be removed, allowing access to the upper and lower screws 56, 54. The user then pulls the screws 56, 54 away from their respective coupling portion 52, 50 and out of the housing. As shown, the upper screw 56 has a grabbing handle 58, FIG. 3 located inside, allowing the user to grasp it and pull the upper screw 56 directly out. It is contemplated that the lower screw 54 has a similar feature.

After cleaning, reinstallation of the components of the system 10 are largely the reverse of their removal. Firstly, the screws 56, 54 are mated where the root 80 meets the scraping surface 74 and the scraping surface 84 meets the root 70. The screws 56, 54 are aligned to allow the coupling portion 52 to mate the interface 76 while simultaneously allowing the coupling portion 50 to mate the interface 86. The cover 88 is then secured to the cooling portion 46.

It is understood that while certain aspects of the disclosed subject matter have been shown and described, the disclosed subject matter is not limited thereto and encompasses various other embodiments and aspects. No specific limitation with respect to the specific embodiments disclosed herein is intended or should be inferred. Modifications may be made to the disclosed subject matter as set forth in the following claims.

What is claimed is:

1. A frozen food dispenser adapted to dispense flowable food, said dispenser comprising:
a housing having a chamber with a first inside diameter intersecting a second inside diameter, said housing having an inlet port extending through said housing and into said chamber near an inlet end and a dispensing port located near an oppositely located dispensing end, said housing adapted to chill said food, said housing having a cooling jacket adapted to chill said housing;
a first screw having a first axis, said first screw having a helical thread with an outer diameter and a root diameter;
a second screw having a second axis, said second screw having a helical thread with an outer diameter and a root diameter;
said first screw rotatably fittable within said first inside diameter of said housing, said outer diameter of said first screw substantially matching said first inside diameter;
said second screw rotatably fittable within said second inside diameter of said housing, said outer diameter substantially matching said second inside diameter;
said helical thread of said first screw adapted to mesh with said helical thread of said second screw, said first screw having a first thread direction, said second screw having a second screw direction, said first and second screw directions being opposite, said screws meshing when said screws are in said housing;
said root diameter of said first screw adapted to mate with said outside diameter of said second screw, said root diameter of said second screw adapted to mate with said outside diameter of said first screw when said screws are in said housing;
said first screw having a first receiver having an interlockable feature adapted to complimentarily mate with an interlockable feature on a first screw driver and rotate therewith, said second screw having a second receiver having an interlockable feature adapted to complimentarily mate with an interlockable feature on a second screw driver and rotate therewith;
said first and second screw driver extending into said chamber, said first screw driver adapted to drive said first screw about said first axis, said second screw driver adapted to drive said second screw about said second axis, said first and second screw drivers linked for counter rotation with respect to each other; and
a motor adapted to control rotation of said drivers.

2. The food dispenser of claim 1, said housing having a removable cover having a first bearing surface adapted to rotatably mate with a terminal end of said first screw and a second bearing surface adapted to rotatably mate with a terminal end of said second screw.

3. The food dispenser of claim 2, said dispensing port including a valve moveable between a closed position and an open position, said closed position defined by said dispensing port obstructed, said open position defined by said dispensing port being substantially unobstructed.

4. The food dispenser of claim 3, a pressure sensor located in close proximity to said dispensing port, said pressure sensor in electrical communication with said motor.

5. The food dispenser of claim 1, a main shaft driving one of said screw drivers and a sensor to detect the rotation of one of said screws, said sensor in electrical communication with said motor.

6. The food dispenser of claim 1, said dispenser having a cooling system with a cooling jacket adapted to chill said housing, said housing having a temperature sensor in electrical communication with said cooling system.

7. The food dispenser of claim 1, said interlockable feature of first screw driver having a ramped surface and a driving surface, said interlockable feature on said first screw having a complimentary ramped surface and a driving surface, said driving surfaces directly contacting when said first screw driver rotates said first screw in one direction, said interlockable feature of said second screw driver having a ramped surface and a driving surface, said interlockable feature on said second screw having a complimentary ramped surface and a driving surface, said driving surfaces directly contacting when said second screw driver rotates said second screw in a direction opposite said one direction.

8. A frozen food dispenser adapted to dispense flowable food, said dispenser comprising:
a housing having a chamber with a first inside diameter intersecting a second inside diameter, said housing having an inlet port extending through said housing and into said chamber near an inlet end and a dispensing port located near an oppositely located dispensing end, said housing adapted to chill said food, said housing having a cooling jacket adapted to chill said housing;
a first screw having a first axis, said first screw having a helical thread with an outer diameter;
a second screw having a second axis, said second screw having a helical thread with an outer diameter;
said first screw rotatably fittable within said first inside diameter of said housing, said second screw rotatably fittable within said second inside diameter of said housing;
said helical thread of said first screw adapted to mesh with said helical thread of said second screw, said first screw having a first thread direction, said second screw having a second screw direction, said first and second screw directions being opposite, said screws meshing when said screws are in said housing;
said first screw having a first receiver having an interlockable feature adapted to complimentarily mate with an interlockable feature on a first screw driver and rotate therewith, said second screw having a second receiver having an interlockable feature adapted to complimentarily mate with an interlockable feature on a second screw driver and rotate therewith;
said first screw driver adapted to drive said first screw about said first axis, said second screw driver adapted to drive said second screw about said second axis, said first and second screw drivers linked for counter rotation with respect to each other; and
a motor adapted to control rotation of said drivers.

9. The food dispenser of claim 8, said first screw having a root diameter, said second screw having a root diameter, said root diameter of said first screw adapted to mate with said outside diameter of said second screw, said root diameter of said second screw adapted to mate with said outside diameter of said first screw.

10. The food dispenser of claim 9, said housing having a removable cover having a first bearing surface adapted to rotatably mate with said first screw, said removable cover having a second bearing surface adapted to rotatably mate with said second screw.

11. The food dispenser of claim 9, said dispensing port including a valve moveable between a closed position and an open position, said closed position defined by said dispensing port obstructed, said open position defined by said dispensing port being substantially unobstructed.

12. The food dispenser of claim 11, a pressure sensor located in close proximity to said dispensing port, said pressure sensor in electrical communication with said motor.

13. The food dispenser of claim 9, a main shaft driving one of said gears and a sensor to detect the rotation of said main shaft, said sensor in electrical communication with said motor.

14. The food dispenser of claim 9, said dispenser having a cooling system with a cooling jacket adapted to chill said housing, said housing having a temperature sensor in electrical communication with said cooling system.

15. The food dispenser of claim 8, said first screw driver having a ramped surface and a driving surface, said first screw having a complimentary ramped surface and a driving surface, said driving surfaces directly contacting when said first screw driver rotates said first screw in one direction, said second screw driver having a ramped surface and a driving surface, said second screw having a complimentary ramped surface and a driving surface, said driving surfaces directly contacting when said second screw driver rotates said second screw in a direction opposite said one direction.

16. A frozen food dispenser adapted to dispense flowable food, said dispenser comprising:
a housing having a chamber with a first inside diameter intersecting a second inside diameter, said housing having an inlet port extending through said housing and into said chamber near an inlet end and a dispensing port located near an oppositely located dispensing end, said housing adapted to chill said food, said housing having a cooling jacket adapted to chill said housing, said housing having a cooling system with a cooling jacket adapted to chill said housing;
a first screw having a first axis, said first screw having a helical thread with an outer diameter;
a second screw having a second axis, said second screw having a helical thread with an outer diameter;
said first screw rotatably fittable within said first inside diameter of said housing, said outer diameter of said first screw substantially matching said first inside diameter;
said second screw rotatably fittable within said second inside diameter of said housing, said outer diameter substantially matching said second inside diameter;
said helical thread of said first screw adapted to mesh with said helical thread of said second screw, said first screw having a first thread direction, said second screw having a second screw direction, said first and second screw directions being opposite, said screws meshing when said screws are in said housing;
said first screw having a first receiver having an interlockable feature adapted to complimentarily mate with an interlockable feature on a first screw driver and rotate therewith, said second screw having a second receiver having an interlockable feature adapted to complimentarily mate with an interlockable feature on a second screw driver and rotate therewith;
said first and second screw driver extending into said chamber, said first screw driver adapted to drive said first screw about said first axis, said second screw driver adapted to drive said second screw about said second axis, said first and second screw drivers linked for counter rotation with respect to each other; and
a motor adapted to control rotation of said drivers.

17. The food dispenser of claim 15, said first screw having a root diameter, said second screw having a root diameter, said root diameter of said first screw adapted to mate with said outside diameter of said second screw, said root diameter of said second screw adapted to mate with said outside diameter of said first screw.

18. The food dispenser of claim 16, said dispensing port including a valve moveable between a closed position and an open position, said closed position defined by said dispensing port obstructed, said open position defined by said dispensing port being substantially unobstructed.

19. The food dispenser of claim 17, a main shaft driving one of said screw drivers and a sensor to detect the rotation of one of said screws, said sensor in electrical communication with said motor.

20. The food dispenser of claim 18, said housing having a temperature sensor in electrical communication with said cooling system.
